(19) United States
(12) Patent Application Publication
(10) Pub. No.: US 2024/0213516 A1
(43) Pub. Date: Jun. 27, 2024

(54) POWER STORAGE CELL MANUFACTURING METHOD AND POWER STORAGE CELL

(71) Applicant: TOYOTA JIDOSHA KABUSHIKI KAISHA, Toyota-shi (JP)

(72) Inventor: Kenichi KAKISHITA, Nagoya-shi (JP)

(73) Assignee: TOYOTA JIDOSHA KABUSHIKI KAISHA, Toyota-shi (JP)

(21) Appl. No.: 18/543,800

(22) Filed: Dec. 18, 2023

(30) Foreign Application Priority Data
Dec. 21, 2022 (JP) 2022-204517

(51) Int. Cl. H01M 10/04; H01M 4/04; H01M 4/70

(52) U.S. Cl. CPC H01M 10/0431; H01M 4/04; H01M 4/70

(57) ABSTRACT

A method of manufacturing a power storage cell includes: a preparing step of preparing an electrode sheet including a current collecting foil and an active material layer; a cutting step of forming a plurality of cuts in the current collecting foil to form a plurality of connecting pieces; and a winding step of winding the electrode sheet around a winding core while bending each of the connecting pieces. The current collecting foil prepared in the preparing step includes a main region and an end region, and the end region includes an edge portion. In the cutting step, a plurality of cuts are formed in the end region to form connecting pieces each having a wide portion and a narrow portion between a pair of cuts. In the winding step, the electrode sheet is wound around the winding core while bending each connecting piece at the narrow portion.

### CROSS REFERENCE TO RELATED APPLICATIONS

This nonprovisional application is based on Japanese Patent Application No. 2022-204517 filed on Dec. 21, 2022 with the Japan Patent Office, the entire contents of which are hereby incorporated by reference.

### BACKGROUND

### Field

The present disclosure relates to a method of manufacturing a power storage cell and a power storage cell.

### Description of the Background Art

Japanese Patent No. 4401634 discloses a rechargeable battery including an electrode plate group that includes a positive electrode plate, a negative electrode plate, and a separator, and a battery case that houses the electrode plate group. A plurality of cuts are formed in a strip-shaped current collecting portion of each electrode plate. The strip-shaped current collecting portion has a plurality of connecting pieces each formed between the cuts. These electrode plates are spirally wound with the separator interposed therebetween to form the group of electrode plates.

### SUMMARY

In the case of the method of manufacturing a power storage cell described in Japanese Patent No. 4401634, when each electrode plate is spirally wound with a separator interposed, the bending position of the connecting pieces may be unstable, which may result in instability of the connection between the connecting pieces and a current collector plate.

It is an object of the present disclosure to provide a method of manufacturing a power storage cell as well as a power storage cell that enable stabilization of the bending position of the connecting pieces during winding.

A method of manufacturing a power storage cell according to an aspect of the present disclosure includes: a preparing step of preparing an electrode sheet including a current collecting foil having a shape elongated in one direction, and an active material layer provided on a surface of the current collecting foil; a cutting step of forming a plurality of cuts in the current collecting foil to form a plurality of connecting pieces that are separated from each other in the one direction; and a winding step of winding the electrode sheet around a winding core while bending each of the plurality of connecting pieces toward the winding core, wherein the current collecting foil of the electrode sheet prepared in the preparing step includes a main region provided with the active material layer, and an end region that is not provided with the active material layer and has a shape continuous in the one direction, and the end region includes an edge portion in an orthogonal direction orthogonal to both the one direction and a thickness direction of the current collecting foil, in the cutting step, the plurality of cuts are formed in the end region to form the connecting pieces, wherein each of the connecting pieces is located between a pair of the cuts adjacent to each other in the one direction, and has a wide portion extending from the edge portion toward the main region, and a narrow portion contiguous to an inside of the wide portion in the direction orthogonal to both the one direction and the thickness direction of the current collecting foil, and having a length in the one direction smaller than a length of the wide portion in the one direction, and in the winding step, the electrode sheet is wound around the winding core while bending, at the narrow portion, each of the plurality of connecting pieces.

A power storage cell according to one aspect of the present disclosure includes: an electrode assembly including a positive electrode sheet, a negative electrode sheet, and a separator, and constructed as a wound body in which the positive electrode sheet and the negative electrode sheet are wound with the separator interposed between the positive electrode sheet and the negative electrode sheet, wherein each of the positive electrode sheet and the negative electrode sheet includes: a current collecting foil; and an active material layer provided on a surface of the current collecting foil, the current collecting foil includes: a main region provided with the active material layer and arranged to overlap with itself in a radial direction of the wound body; and an end region formed outside the main region in an axial direction of the wound body, the end region being not provided with the active material layer, the end region has a plurality of cuts formed at intervals in a circumferential direction of the wound body to define a plurality of connecting pieces that are separated from each other in the circumferential direction and leaned inward in the radial direction, and each of the plurality of cuts includes: a slit extending outward in the radial direction, from an edge portion of the end region in the radial direction; and a curved portion contiguous to an outer end of the slit in the radial direction.

These and other objects, features, aspects and advantages of the disclosure will become apparent from the following detailed description of the disclosure, which is understood in conjunction with the accompanying drawings.

### BRIEF DESCRIPTION OF THE DRAWINGS

FIG. 1 is a partial cross-sectional view schematically showing a power storage cell according to an embodiment of the present disclosure.

FIG. 2 is a plan view schematically showing a positive electrode sheet before winding.

FIG. 3 is a view schematically showing a modified example of the cut and the connecting piece.

FIG. 4 is a view schematically showing a modified example of the cut and the connecting piece.

FIG. 5 is a view schematically showing a modified example of the cut and the connecting piece.

### DESCRIPTION OF THE PREFERRED EMBODIMENTS

Embodiments of the present disclosure will be described with reference to the drawings. In the drawings referred to below, the same or corresponding members are denoted by the same reference numerals.

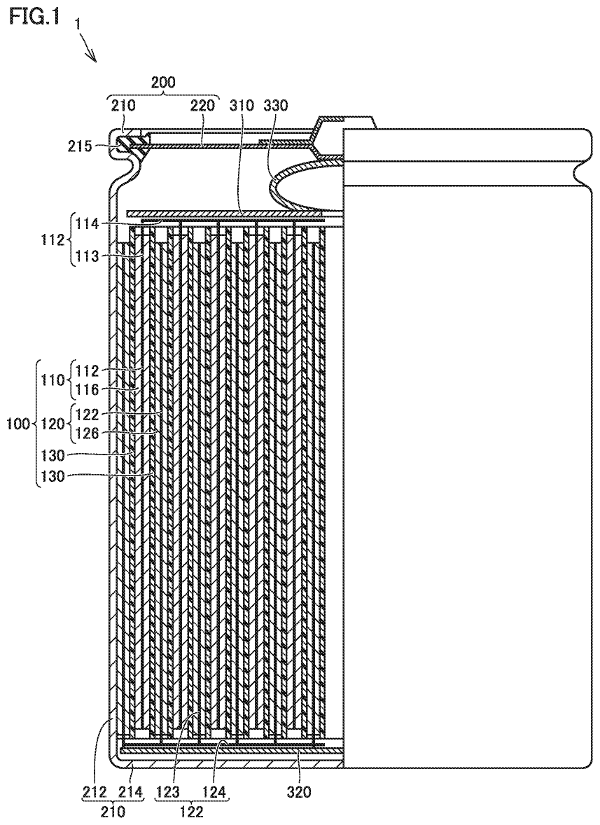

FIG. 1 is a partial cross-sectional view schematically showing a power storage cell according to an embodiment of the present disclosure. The power storage cell 1 is preferably mounted on a vehicle.

As shown in FIG. 1, the power storage cell 1 includes an electrode assembly 100, a cell case 200, a positive electrode current collector plate 310, a negative electrode current collector plate 320, and a coupling lead 330.

The electrode assembly 100 includes a positive electrode sheet 110, a negative electrode sheet 120, and a separator 130. The electrode assembly 100 is a wound body formed by winding a positive electrode sheet 110 and a negative electrode sheet 120 with a separator 130 interposed therebetween.

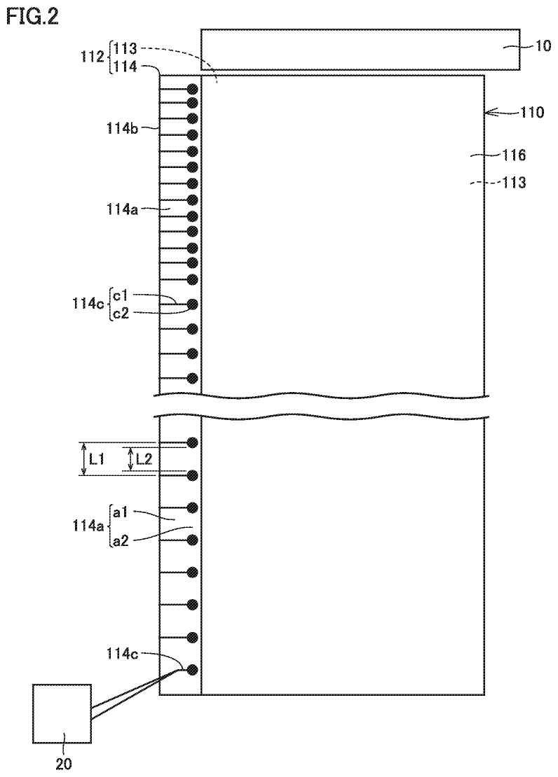

FIG. 2 is a plan view schematically showing a positive electrode sheet before winding. As shown in FIGS. 1 and 2, the positive electrode sheet 110 includes a positive electrode current collecting foil 112 and a positive electrode active material layer 116.

The positive electrode current collecting foil 112 is made of a metal such as aluminum. As shown in FIG. 2, the positive electrode current collecting foil 112 before winding has a shape elongated in one direction (vertical direction in FIG. 2). The positive electrode current collecting foil 112 has a main region 113 and an end region 114.

The main region 113 is a region in which the positive electrode active material layer 116 is provided in the positive electrode current collecting foil 112. As shown in FIG. 1, the main region 113 is arranged to overlap with itself in the radial direction of the wound body (electrode assembly 100).

The end region 114 is a region in which the positive electrode active material layer 116 is not provided in the positive electrode current collecting foil 112. As shown in FIG. 1, the end region 114 is formed outside (upper side in FIG. 1) the main region 113 in the axial direction (vertical direction in FIG. 1) of the electrode assembly 100.

The end region 114 has a plurality of connecting pieces 114a (see FIG. 2) separated from each other in the circumferential direction of the electrode assembly 100. Each connecting piece 114a leans inward in the radial direction. The upper surface of each connecting piece 114a forms a substantially flat surface.

The negative electrode sheet 120 includes a negative electrode current collecting foil 122 made of a metal such as copper, and a negative electrode active material layer 126 provided on the surface of the negative electrode current collecting foil 122.

The structure of the negative electrode current collecting foil 122 is substantially the same as the structure of the positive electrode current collecting foil 112. Therefore, the description of the negative electrode current collecting foil 122 is simplified. That is, the negative electrode current collecting foil 122 has a main region 123 in which the negative electrode active material layer 126 is provided, and an end region 124 formed on the outside (lower side in FIG. 1) of the main region 123 in the axial direction. The end region 124 has a plurality of connecting pieces that lean inward in the radial direction.

The separator 130 is disposed between the positive electrode sheet 110 and the negative electrode sheet 120. More specifically, the separator 130 is disposed only between the main region 113 of the positive electrode sheet 110 and the main region 123 of the negative electrode sheet 120 adjacent to each other in the radial direction. The separator 130 is made of an insulating material and allows penetration of ions.

The cell case 200 houses the electrode assembly 100. The cell case 200 also contains an electrolyte solution (not shown). The cell case 200 is sealed. The cell case 200 includes a case body 210 and a lid 220.

The case body 210 opens upward. The case body 210 is made of metal such as aluminum. The case body 210 includes a bottom wall 212 and a peripheral wall 214. The bottom wall 212 is formed in a disc shape. The peripheral wall 214 rises from the edge of the bottom wall 212 and is formed in a cylindrical shape.

The lid 220 closes the opening of the case body 210. The lid 220 is connected to the case body 210 via a sealing member 215.

The positive electrode current collector plate 310 is disposed above the electrode assembly 100. The positive electrode current collector plate 310 is connected to the upper surface of each connecting piece 114a of the positive electrode current collecting foil 112 by welding or the like.

The negative electrode current collector plate 320 is disposed below the electrode assembly 100. The negative electrode current collector plate 320 is connected to an upper surface of each connecting piece of the negative electrode current collecting foil 122 by welding or the like.

The coupling lead 330 connects the positive electrode current collector plate 310 and the lid 220.

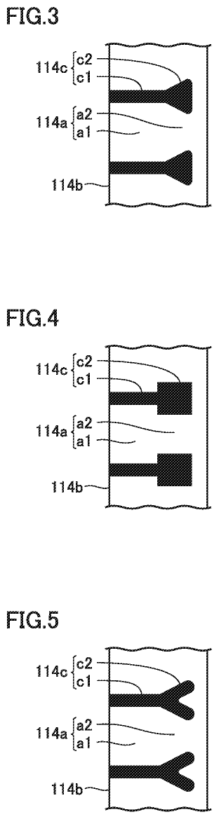

Next, a method of manufacturing the power storage cell 1 will be described with reference to FIGS. 2 and 3. This manufacturing method includes a preparing step, a cutting step, and a winding step. Hereinafter, the positive electrode sheet 110 and the negative electrode sheet 120 are referred to as “electrode sheet”, the positive electrode current collecting foil 112 and the negative electrode current collecting foil 122 are referred to as “current collecting foil”, and the positive electrode active material layer 116 and the negative electrode active material layer 126 are referred to as “active material layer”. In FIGS. 2 and 3, the positive electrode sheet 110 is shown as an example. In FIG. 3, illustration of the separator 130 is omitted.

In the preparing step, an electrode sheet is prepared. Specifically, in the preparing step, an electrode sheet including a current collecting foil having a shape elongated in one direction (the vertical direction in FIG. 2) and an active material layer provided on the surface of the current collecting foil is prepared. The respective current collecting foils of the electrode sheets 110 and 120 prepared in the preparing step include main regions 113 and 123 and end regions 114 and 124. The main regions 113 and 123 are formed, for example, by providing an active material layer on a current collecting foil conveyed by a conveying roll. The end regions 114 and 124 are adjacent to the main regions 113 and 123 in the orthogonal direction (the left-right direction in FIG. 2) orthogonal to both the one direction and the thickness direction of the current collecting foil. The lengths of the main regions 113 and 123 in the orthogonal direction are set to 80 mm, for example, and the lengths of the end regions 114 and 124 in the orthogonal direction are set to 5 mm, for example. The end regions 114 and 124 are in a shape continuous in one direction. The end regions 114, 124 include an edge portion 114b in the orthogonal direction.

In the cutting step, by forming a plurality of cuts 114c in the current collecting foil, a plurality of connecting pieces 114a separated from each other in one direction are formed. Specifically, in the cutting step, a plurality of cuts 114c are formed in the end region 114 so that the connecting piece 114a having the wide portion a1 and the narrow portion a2 is formed.

As shown in FIG. 2, in the cutting step, a cut 114c having a slit c1 and an extended portion c2 is formed in the end regions 114 and 124. The slit c1 extends from the edge portion 114b toward the main regions 113 and 123. The slit c1 may be formed parallel to the orthogonal direction. The extended portion c2 is contiguous to the slit c1. The extended portion c2 has a shape with its length in one direction gradually increasing from the slit c1 toward the main regions 113 and 123. In the present embodiment, the extended portion c2 is formed in a circular shape. The extended portion c2 forms a curved portion having a shape which is curved so as to protrude toward the main regions 113 and 123. The length of the slit c1 in one direction is, for example, 0.05 mm, and the length of the extended portion c2 in the one direction is, for example, 0.1 mm. The length of the cut 114c in the orthogonal direction is, for example, about 4 mm. For example, each cut 114c may be formed by laser radiation from a laser irradiation unit 20 as shown in FIG. 2, or may be formed by a blade. FIG. 2 shows the positive electrode sheet 110 of the electrode sheet after the cutting step.

In the end regions 114 and 124, a plurality of connecting pieces 114a are defined by a plurality of cuts 114c. As shown in FIG. 2, each connecting piece 114a has a wide portion a1 and a narrow portion a2.

The wide portion a1 extends from the edge portion 114b toward the main regions 113 and 123. The wide portion a1 is formed between a pair of slits c1 adjacent to each other in one direction.

The narrow portion a2 is contiguous to the inside of the wide portion a1 in the orthogonal direction. The length L2 of the narrow portion a2 in one direction is shorter than the length L1 of the wide portion a1 in the one direction. The narrow portion a2 is formed between a pair of extended portions c2 adjacent to each other in the one direction.

In the winding step, the electrode sheet and the separator 130 are wound around the winding core 10 (see FIG. 2). As shown in FIG. 2, the electrode sheet is wound around the winding core 10 at a position where the active material layer overlaps the winding core 10. The separator 130 is disposed at a position overlapping only the main regions 113 and 123.

In the winding step, the electrode sheet and the separator 130 are wound around the winding core 10 while the connecting pieces 114a are each bent toward the winding core 10. More specifically, in the winding step, the electrode sheet and the separator 130 are wound around the winding core 10 while the connecting pieces 114a are each bent at the narrow portion a2.

As described above, in the method of manufacturing the power storage cell 1 according to the present embodiment, the narrow portion a2 is formed inside the wide portion a1 in the orthogonal direction in the cutting step. Since the bending stiffness of the narrow portion a2 is lower than the bending stiffness of the wide portion a1, the bending position of each connecting piece 114a is effectively determined to be the narrow portion a2 in the winding step.

In the above embodiment, the shape of the extended portion c2 formed in the cutting step may be formed as shown in FIGS. 3 to 5. In the example shown in FIG. 3, the corner portion of the extended portion c2 in one direction is formed in a curved shape. In the example shown in FIG. 4, the extended portion c2 is formed in a rectangular shape. It is preferable that each corner of the rectangle is formed in a curved shape. In the example shown in FIG. 5, the extended portion c2 branches into portions that are separate from each other in one direction.

It will be appreciated by those skilled in the art that the exemplary embodiments described above are specific examples of the following aspects.

[Aspect 1]

A method of manufacturing a power storage cell, the method including:
a preparing step of preparing an electrode sheet including
   a current collecting foil having a shape elongated in one direction, and
   an active material layer provided on a surface of the current collecting foil;
a cutting step of forming a plurality of cuts in the current collecting foil to form a plurality of connecting pieces that are separated from each other in the one direction; and
a winding step of winding the electrode sheet around a winding core while bending each of the plurality of connecting pieces toward the winding core, wherein
the current collecting foil of the electrode sheet prepared in the preparing step includes
   a main region provided with the active material layer, and
   an end region that is not provided with the active material layer and has a shape continuous in the one direction, and the end region includes an edge portion in an orthogonal direction orthogonal to both the one direction and a thickness direction of the current collecting foil,
in the cutting step, the plurality of cuts are formed in the end region to form the connecting pieces, wherein each of the connecting pieces is located between a pair of the cuts adjacent to each other in the one direction, and has a wide portion extending from the edge portion toward the main region, and a narrow portion contiguous to an inside of the wide portion in the direction orthogonal to both the one direction and the thickness direction of the current collecting foil, and having a length in the one direction smaller than a length of the wide portion in the one direction, and
in the winding step, the electrode sheet is wound around the winding core while bending, at the narrow portion, each of the plurality of connecting pieces.

In the method of manufacturing a power storage cell, the narrow portion is formed inside the wide portion in the orthogonal direction in the cutting step. Since the bending stiffness of the narrow portion is lower than the bending stiffness of the wide portion, the bending position of each connecting piece is effectively determined to be the narrow portion in the winding step.

[Aspect 2]

The method of manufacturing a power storage cell according to Aspect 1, wherein in the cutting step, the cuts are each formed to include:
a slit having a shape extending from the edge portion toward the main region, and defining the wide portion; and
an extended portion having a shape with a length in the one direction increasing gradually from the slit toward the main region, and defining the narrow portion.

[Aspect 3]

A power storage cell including:
an electrode assembly including a positive electrode sheet, a negative electrode sheet, and a separator, and constructed as a wound body in which the positive electrode sheet and the negative electrode sheet are wound with the separator interposed between the positive electrode sheet and the negative electrode sheet, wherein
each of the positive electrode sheet and the negative electrode sheet includes:
   a current collecting foil; and
   an active material layer provided on a surface of the current collecting foil,
the current collecting foil includes:
   a main region provided with the active material layer and arranged to overlap with itself in a radial direction of the wound body; and
   an end region formed outside the main region in an axial direction of the wound body, the end region being not provided with the active material layer,
the end region has a plurality of cuts formed at intervals in a circumferential direction of the wound body to define a plurality of connecting pieces that are separated from each other in the circumferential direction and leaned inward in the radial direction, and
each of the plurality of cuts includes:
   a slit extending outward in the radial direction, from an edge portion of the end region in the radial direction; and
   a curved portion contiguous to an outer end of the slit in the radial direction.

In this power storage cell, each cut has a curved portion, and therefore, occurrence of stress concentration on the curved portion is suppressed. Accordingly, when an external force acts on the connecting piece due to expansion/contraction of the electrode assembly, collision of the vehicle, or the like, it is possible to prevent the cut from opening at its bottom (root).

[Aspect 4]

An electrode sheet that is wound together with a separator to form an electrode assembly constructed as a wound body, the electrode sheet including:
a current collecting foil having a shape elongated in one direction; and
an active material layer provided on a surface of the current collecting foil,
   wherein
the current collecting foil includes:
   a main region provided with the active material layer; and
   an end region including an edge portion in an orthogonal direction orthogonal to both the one direction and a thickness direction of the current collecting foil, the end region is continuous in the one direction, and the end region is not provided with the active material layer,
the end region has a plurality of cuts formed at intervals in the one direction to define a plurality of connecting pieces connected to a current collector, and
the plurality of cuts each include:
   a slit extending outward in the radial direction, from an edge portion of the end region in the radial direction; and
   a curved portion contiguous to an outer end of the slit in the radial direction.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A method of manufacturing a power storage cell, the method comprising:
a preparing step of preparing an electrode sheet including
a current collecting foil having a shape elongated in one direction, and
an active material layer provided on a surface of the current collecting foil;
a cutting step of forming a plurality of cuts in the current collecting foil to form a plurality of connecting pieces that are separated from each other in the one direction; and
a winding step of winding the electrode sheet around a winding core while bending each of the plurality of connecting pieces toward the winding core, wherein
the current collecting foil of the electrode sheet prepared in the preparing step includes
a main region provided with the active material layer, and
an end region that is not provided with the active material layer and has a shape continuous in the one direction, and the end region includes an edge portion in an orthogonal direction orthogonal to both the one direction and a thickness direction of the current collecting foil,
in the cutting step, the plurality of cuts are formed in the end region to form the connecting pieces, wherein each of the connecting pieces is located between a pair of the cuts adjacent to each other in the one direction, and has a wide portion extending from the edge portion toward the main region, and a narrow portion contiguous to an inside of the wide portion in the direction orthogonal to both the one direction and the thickness direction of the current collecting foil, and having a length in the one direction smaller than a length of the wide portion in the one direction, and
in the winding step, the electrode sheet is wound around the winding core while bending, at the narrow portion, each of the plurality of connecting pieces.

2. The method of manufacturing a power storage cell according to claim 1, wherein in the cutting step, the cuts are each formed to include:
a slit having a shape extending from the edge portion toward the main region, and defining the wide portion; and
an extended portion having a shape with a length in the one direction increasing gradually from the slit toward the main region, and defining the narrow portion.

3. A power storage cell comprising:
an electrode assembly including a positive electrode sheet, a negative electrode sheet, and a separator, and constructed as a wound body in which the positive electrode sheet and the negative electrode sheet are wound with the separator interposed between the positive electrode sheet and the negative electrode sheet, wherein
each of the positive electrode sheet and the negative electrode sheet includes:
a current collecting foil; and
an active material layer provided on a surface of the current collecting foil,
the current collecting foil includes:
a main region provided with the active material layer and arranged to overlap with itself in a radial direction of the wound body; and
an end region formed outside the main region in an axial direction of the wound body, the end region being not provided with the active material layer,
the end region has a plurality of cuts formed at intervals in a circumferential direction of the wound body to define a plurality of connecting pieces that are separated from each other in the circumferential direction and leaned inward in the radial direction, and
each of the plurality of cuts includes:
a slit extending outward in the radial direction, from an edge portion of the end region in the radial direction; and
a curved portion contiguous to an outer end of the slit in the radial direction.
